(19) United States
(12) Patent Application Publication
(10) Pub. No.: US 2016/0201416 A1
(43) Pub. Date: Jul. 14, 2016

(54) Clad Hardfacing Application on Downhole Cutting Tools

(71) Applicant: HALLIBURTON ENERGY SERVICES, INC., Houston, TX (US)

(72) Inventors: Andrew Scott Gendre, Edmonton (CA); William Shaun Renshaw, Edmonton (CA)

(73) Assignee: Halliburton Energy Services, Inc., Houston, TX (US)

(21) Appl. No.: 14/912,155

(22) PCT Filed: Sep. 30, 2013
(86) PCT No.: PCT/US2013/062694

§ 371 Date: Feb. 15, 2016

(51) Int. Cl. E21B 29/00; B23P 15/34

(52) U.S. Cl. CPC E21B 29/002; B23P 15/34

(57) ABSTRACT

A downhole milling tool for cutting non-geological materials in a well includes a body having an elongated and substantially cylindrical wall defining an inner passage extending through a portion of the body. The body includes a coupling end capable of being coupled to a working string to rotate the body. A plurality of blades extends radially outward from the body, and each blade extends along a length of the body. Each blade is oriented substantially parallel to a longitudinal axis of the body or is arranged in a spiral or helical configuration on the body. A laser-deposited cladding material is coupled to the plurality of blades.

### BACKGROUND

1. Field of the Invention

The present disclosure relates generally to the recovery of subterranean deposits and more specifically to methods and systems for milling materials in a well.

2. Description of Related Art

Wells are drilled at various depths to access and produce oil, gas, minerals, and other naturally-occurring deposits from subterranean geological formations. Hydrocarbons may be produced through a wellbore traversing the subterranean formations. The wellbore may be relatively complex and include, for example, one or more lateral branches extending at an angle from a parent or main wellbore. Forming lateral wellbores typically involves first creating a window in a casing or other metal tubing lining the main wellbore. A window mill or other milling tool may be used initiate and form the window. After the window is created, a drill bit may be passed through the window to form the lateral wellbore.

In additional to milling windows for lateral wellbore formation, milling tools may be used for many other downhole tasks, some of which include downhole cleaning functions, removal of plugs, debris removal, casing restoration, and other functions. Milling tools typically are used to cut through metallic objects or other materials that have been delivered into the wellbore. While milling tools may include hardened cutters or inserts to improve cutting performance and wear resistance, the hardened cutters often break free from the milling tools during use thereby causing quicker wear of the tool.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, without departing from the scope of this disclosure.

FIG. 1A illustrates an isometric front view of a downhole milling tool according to an illustrative embodiment;

FIG. 1B illustrates an orthogonal side view of the downhole milling tool of FIG. 1A;

FIG. 2A illustrates a front view of a downhole milling tool according to an illustrative embodiment;

FIG. 2B illustrates a side view of the downhole milling tool of FIG. 2A;

FIG. 3A illustrates a front view of a downhole milling tool according to an illustrative embodiment;

FIG. 3B illustrates a side view of the downhole milling tool of FIG. 3A;

FIG. 4 illustrates a cross-sectional side view of a blade of a milling tool according to an illustrative embodiment, the blade having a cladding material coupled to the blade;

FIG. 5A illustrates a cross-sectional side view of a blade of a milling tool according to an illustrative embodiment, the blade having a cladding material coupled to the blade and a plurality of cutting inserts coupled to the cladding material;

FIG. 5B illustrates a cross-sectional side view of one of the cutting inserts of FIG. 5A; and

FIG. 6 illustrates a cross-sectional side view of a blade of a milling tool according to an illustrative embodiment, the blade having a cladding material coupled to the blade and a plurality of cutting inserts coupled to the cladding material.

### DETAILED DESCRIPTION OF ILLUSTRATIVE EMBODIMENTS

In the following detailed description of the illustrative embodiments, reference is made to the accompanying drawings that form a part hereof These embodiments are described in sufficient detail to enable those skilled in the art to practice the invention, and it is understood that other embodiments may be utilized and that logical structural, mechanical, electrical, and chemical changes may be made without departing from the spirit or scope of the invention. To avoid detail not necessary to enable those skilled in the art to practice the embodiments described herein, the description may omit certain information known to those skilled in the art. The following detailed description is, therefore, not to be taken in a limiting sense, and the scope of the illustrative embodiments is defined only by the appended claims.

The embodiments described herein relate to systems, tools, and methods for milling materials in a well, particularly metallic and non-geological materials. While milling tools are sometimes used to remove a small amount of geological material following milling of metallic and other materials, milling tools, unlike drill bits, are not designed principally to remove rock and other geological material. Embodiments of milling tools described herein include blades having a cladding material coupled to the blades, and it is these blades that are responsible for cutting metallic materials in the well. The cladding material may be coupled to the blades in various ways, but the cladding material may form a metallurgical bond with the blades. In addition to the cladding material, cutting inserts may be coupled to the cladding material, and may extend beyond an outer surface of the cladding material. By securing the cutting inserts with the cladding material, improved wear resistance and longevity of the milling tools may be achieved. The cladding material, through metallurgical bonds to the cutting inserts and blades, is able to more securely retain the cutting inserts than traditional brazing material. Furthermore, the process of applying the cladding material to the blades and cutting inserts may include methods that do not require as much heat as brazing, thereby protecting the base material of the blade itself from heat-induced weakening.

Unless otherwise specified, any use of any form of the terms “connect,” “engage,” “couple,” “attach,” or any other term describing an interaction between elements is not meant to limit the interaction to direct interaction between the elements and may also include indirect interaction between the elements described. In the following discussion and in the claims, the terms “including” and “comprising” are used in an open-ended fashion, and thus should be interpreted to mean “including, but not limited to”. Unless otherwise indicated, as used throughout this document, “or” does not require mutual exclusivity.

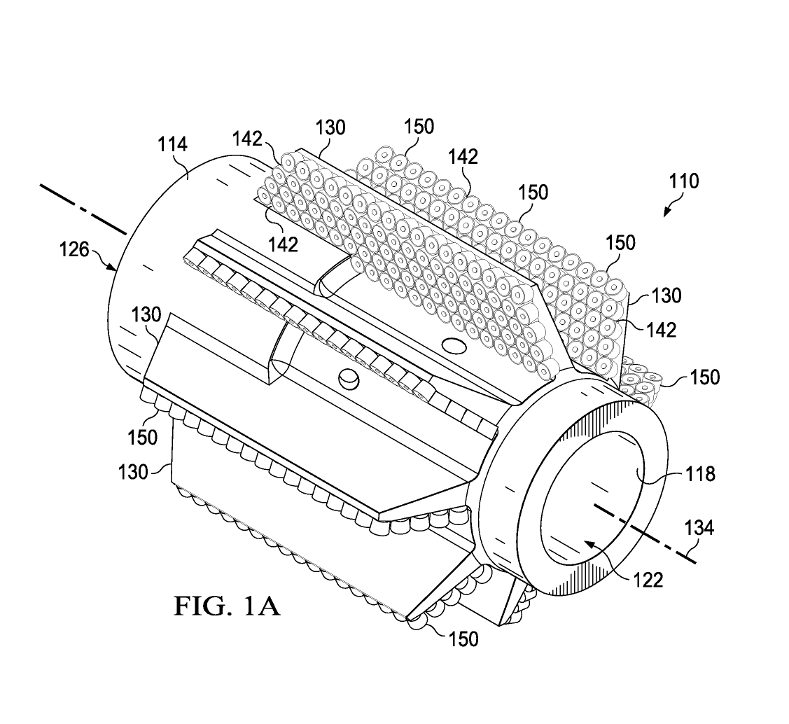

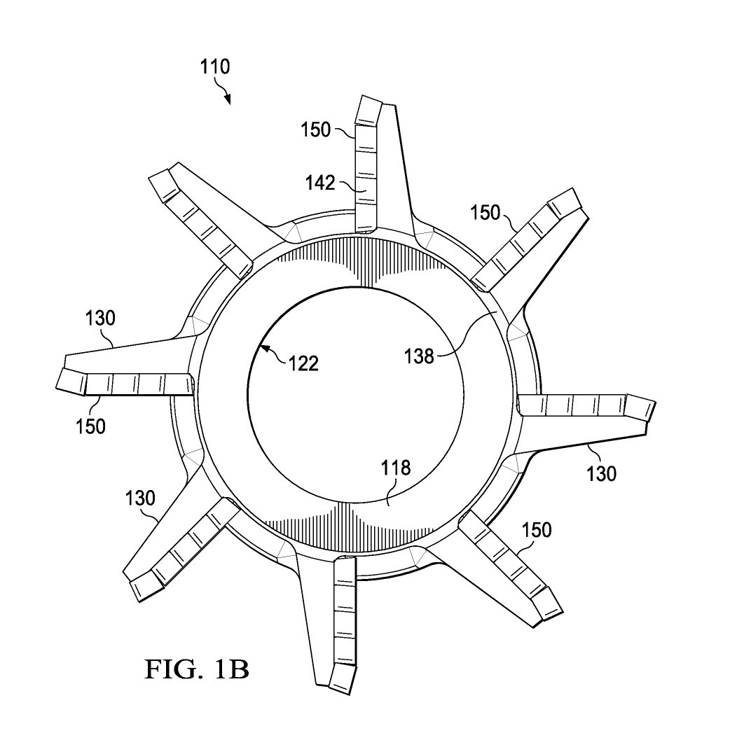

Referring to FIGS. 1A and 1B, isometric front and orthogonal side views of a downhole milling tool 110 according to an illustrative embodiment are presented. The downhole milling tool 110 includes a body 114 having an elongated and substantially cylindrical wall 118 that defines an inner passage 122 extending through a portion of the body 114. On a coupling end 126 of the body 114, the body 114 includes threads or other attachment components that allow the body 114 to be coupled to a working string (not shown) positioned in the wellbore. The working string is capable of rotating the body 114.

The downhole milling tool 110 further includes a plurality of blades 130 extending radially outward from the body 114. Each blade 130 extends along a length of the body and is oriented substantially parallel to a longitudinal axis 134 of the body 114. In the embodiment illustrated in FIGS. 1A and 1B, a thickness of each blade 130 is non-uniform, and each blade is tapered such that a thicker portion of the blade 130 is adjacent a base 138 of the blade 130 where the blade 130 is coupled to the body 114. A thinner portion of the blade 130 is at an end of the blade 130 opposite the base 138.

The downhole milling tool 110 further includes a cladding material 142 coupled to one or more of the blades 130, and in some embodiments, the cladding material 142 is coupled to each of the blades 130. The cladding material 142 may be any material that has a higher hardness than the material from which the blade 130 is formed. In some embodiments, the hardness of the cladding material may be greater than or equal to approximately 60 HRC. The hardness of the cladding material 142 and thus the wear resistance of the blade 130 may be supplemented by including a plurality of cutting inserts 150 coupled to the cladding material 142. The cutting inserts 150 may be at least partially embedded within the cladding material 142 such that the bond between the cladding material 142 and the cutting inserts 150 and between the cladding material 142 and the blade 130 secures the cutting inserts 150 to the blade 130. It should be noted that while some of the cutting inserts 150 may contact the blade 130, no bond necessarily exists between the cutting insets 150 and the blade 130. When cutting inserts 150 are coupled to the cladding material 142, a high-hardness iron-based cladding may be used, such as Apollo-Clad 1403 Powder supplied by Apollo-Clad. As explained in more detail below, powder-based cladding materials may be applied to a blade by using a laser to melt the powder and create the necessary bond between the cladding material and the blade or cutting inserts. Cladding materials such as the Apollo-Clad 1403 Powder have a hardness of approximately 60-65 HRC.

In some embodiments, as an alternative to the use of cutting inserts 150, the cladding material 142 alone may be coupled to the blade 130 and used to provide the increased cutting performance and wear resistance that is desired. In such an embodiment, it is desired that the cladding material 142 have an even higher hardness than materials used in conjunction with the cutting inserts 150. In some embodiments, it is desired that the hardness of such a material be greater than or equal to approximately 60 HRC. An example of a cladding material that may be coupled to the blade 130 and used alone without cutting inserts 150 is a material that includes approximately 62 weight percent Tungsten Carbide, approximately 30 weight percent Nickel, and approximately 6 weight percent Chromium. A suitable material may be WC200 supplied by Kennametal Conforma Clad of New Albany, Ind. The hardness of this material is approximately 64-70 HRC.

In some embodiments the coupling between the cladding material 142 and the blades 130 forms a metallurgical bond. Traditional milling tools may employ hardened inserts to increase wear resistance, but these inserts are brazed to the blades of the milling tool. The brazing matrix that holds the inserts does not have high hardness properties, and since the bonds between the brazing matrix and inserts are only mechanical, as opposed to metallurgical, the inserts are easily released by the brazing matrix during use of the milling tool. In contrast, the metallurgical bonds between the cladding material 142 and blades 130 (and in some embodiments, between the cladding material 142 and cutting inserts 150), provides much more resistance to wear and removal from the blades. Generally accepted brazing strength is approximately 25,000 psi whereas the strength of a metallurgical bond such as that provided by a cladding material may be 70,000 psi, thereby yielding two to three times the bond strength. The increased hardness of the cladding material 142 relative to brazing matrix also increases wear resistance, and in some embodiments, allows the cladding material 142 to be used without cutting inserts 150.

The application of the cladding material 142 to the blades 130 also typically involves less heat than brazing activities. The addition of brazing matrix and hardened inserts may alter heat the blades to such a temperature that the strength or ductility of the blades is compromised, thereby requiring additional heat treatment steps to ensure suitable working life. In contrast, the addition of the cladding material 142 to the blades does not heat the blades 130 to a level that degrades the strength or ductility of the blades 130.

Coupling of the cladding material 142 to the blades 130 (and to the cutting inserts 150 in certain embodiments) may be performed by various processes, including roll welding, explosive welding, and laser cladding. In laser cladding, the cladding material 142 is delivered to a nozzle in powder form. The powder-based cladding material 142 is carried by an inert gas to the blade 130, where a laser beam is defocused on a particular spot to form a melt pool. Either the laser optics and powder nozzle are moved (or the blade is moved) as tracks of cladding material 142 are added to the blade 130.

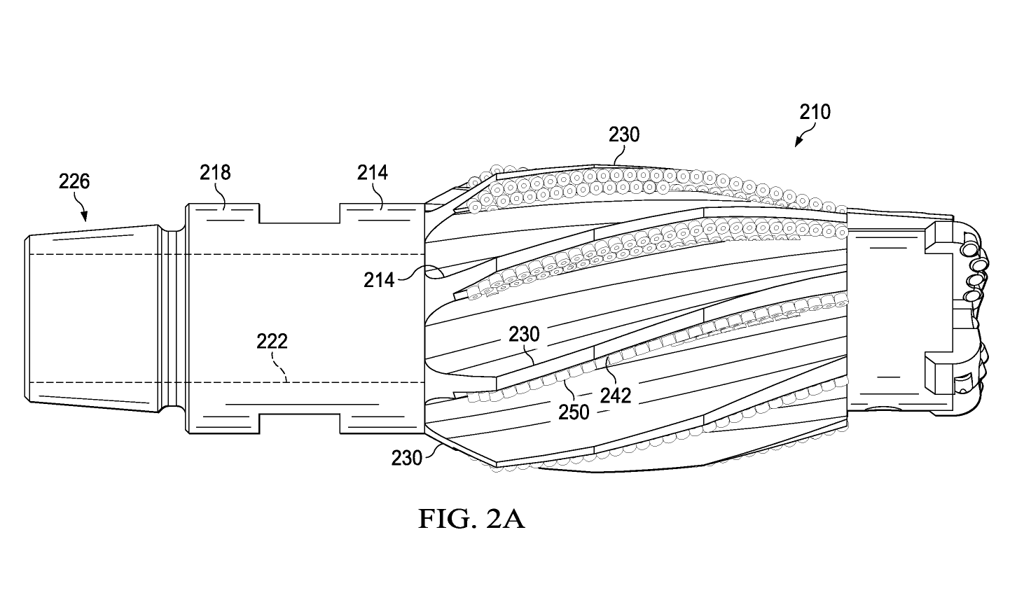

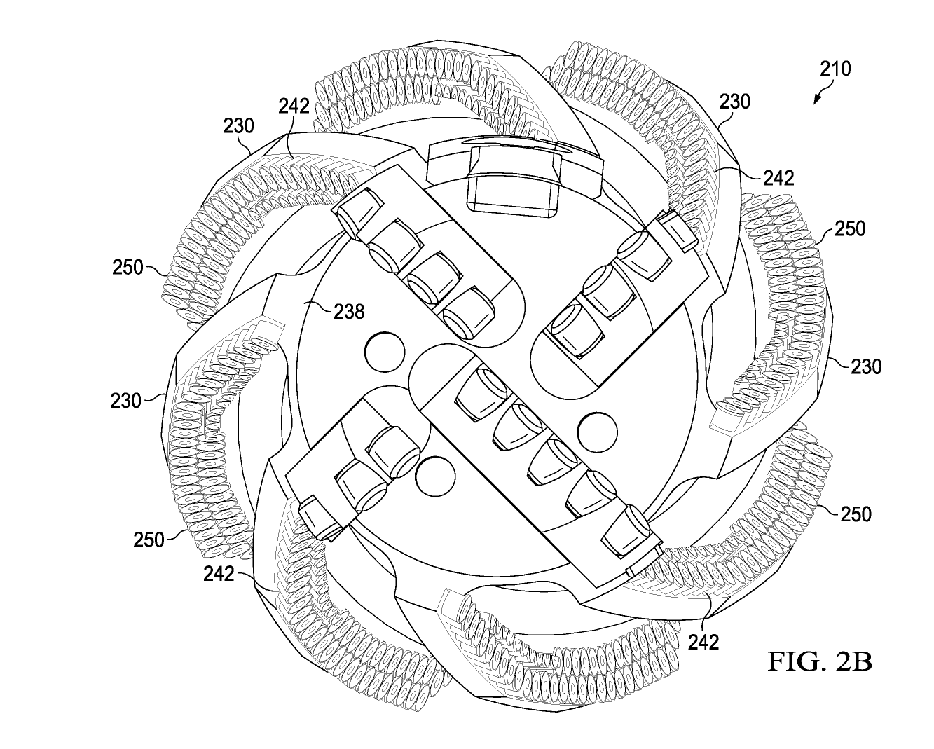

Referring to FIGS. 2A and 2B, front and side views of a downhole milling tool 210 according to an illustrative embodiment are illustrated. The downhole milling tool 210 includes a body 214 having an elongated and substantially cylindrical wall 218 that defines an inner passage 222 extending through a portion of the body 214. On a coupling end 226 of the body 214, the body 214 includes threads or other attachment components that allow the body 214 to be coupled to a working string (not shown) positioned in the wellbore. The working string is capable of rotating the body 214.

The downhole milling tool 210 further includes a plurality of blades 230 extending radially outward from the body 214. Each blade 230 extends along a portion of a length of the body and is arranged in a spiral or helical configuration on the body 214 relative to a longitudinal axis 234 of the body 214. In the embodiment illustrated in FIGS. 2A and 2B, a thickness of each blade 230 is substantially uniform. In other embodiments, the thickness of the blades 230 may be non-uniform, and each blade may be tapered such that a thicker portion of the blade 230 is adjacent a base 238 of the blade 230 where the blade 230 is coupled to the body 214.

The downhole milling tool 210 further includes a cladding material 242 coupled to one or more of the blades 230, and in some embodiments, the cladding material 242 is coupled to each of the blades 230. The cladding material 242 may be any material that has a higher hardness than the material from which the blade 230 is formed. In some embodiments, the hardness of the cladding material may be greater than or equal to approximately 60 HRC. The hardness of the cladding material 242 and thus the wear resistance of the blade 230 may be supplemented by including a plurality of cutting inserts 250 coupled to the cladding material 242. The cutting inserts 250 may be at least partially embedded within the cladding material 242 such that the bond between the cladding material 242 and the cutting inserts 250 and between the cladding material 242 and the blade 230 secures the cutting inserts 250 to the blade 230. It should be noted that while some of the cutting inserts 250 may contact the blade 230, no bond necessarily exists between the cutting insets 250 and the blade 230. When cutting inserts 250 are coupled to the cladding material 242, a high-hardness iron-based cladding may be used, such as Apollo-Clad 1403 Powder supplied by Apollo-Clad. As explained in more detail below, powder-based cladding materials may be applied to a blade by using a laser to melt the powder and create the necessary bond between the cladding material and the blade or cutting inserts.

Cladding materials such as the Apollo-Clad 1403 Powder have a hardness of approximately 60-65 HRC.

In some embodiments, as an alternative to the use of cutting inserts 250, the cladding material 242 alone may be coupled to the blade 230 and used to provide the increased cutting performance and wear resistance that is desired. In such an embodiment, it is desired that the cladding material 242 have an even higher hardness than materials used in conjunction with the cutting inserts 250. In some embodiments, it is desired that the hardness of such a material be greater than or equal to about 70 HRC. An example of a cladding material that may be coupled to the blade 230 and used alone without cutting inserts 250 is a material that includes approximately 62 weight percent Tungsten Carbide, approximately 30 weight percent Nickel, and approximately 6 weight percent Chromium. A suitable material may be WC200 supplied by Kennametal Conforma Clad of New Albany, Ind. The hardness of this material is approximately 64-70 HRC.

Like the milling tool 110 illustrated in FIGS. 1A and 1B, the milling tool 210 may benefit from the metallurgical bond between the cladding material 242, the blades 230, and the cutting inserts 250, if applicable. Again, coupling of the cladding material 242 to the blades 230 (and to the cutting inserts 250 in certain embodiments) may be performed by various processes, including roll welding, explosive welding, and laser cladding.

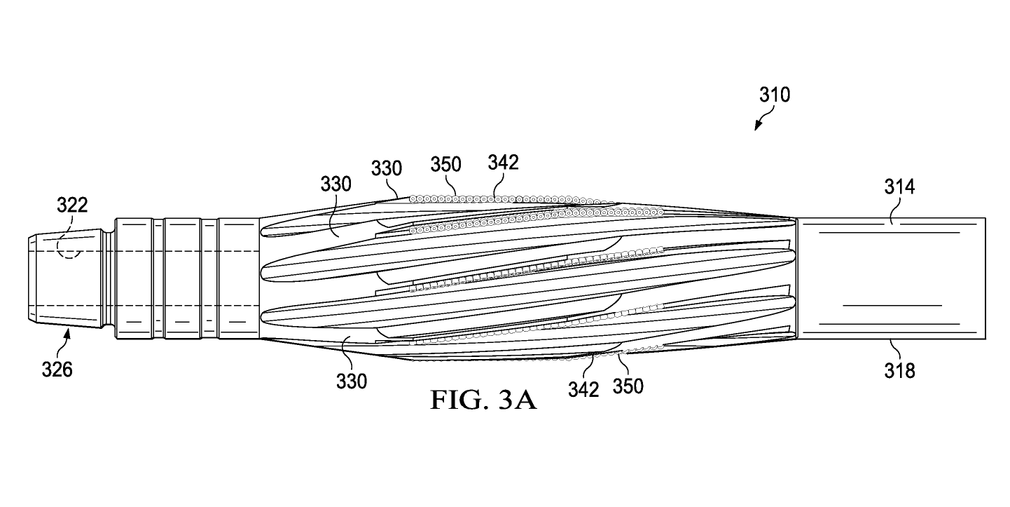

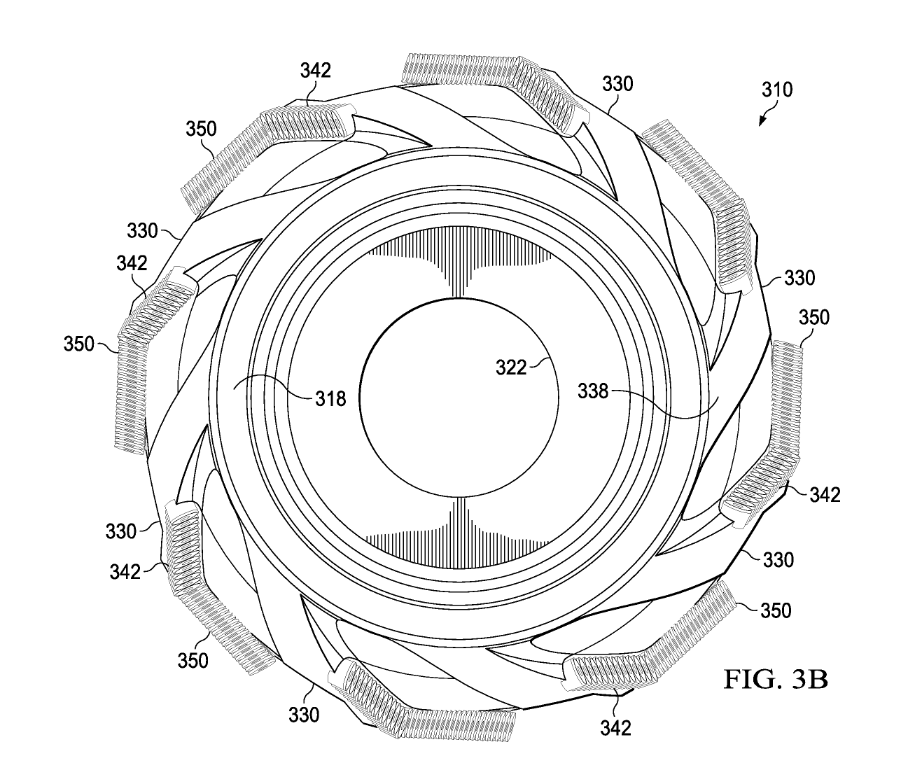

Referring to FIGS. 3A and 3B, front and side views of a downhole milling tool 310 according to an illustrative embodiment are illustrated. The downhole milling tool 310 includes a body 314 having an elongated and substantially cylindrical wall 318 that defines an inner passage 322 extending through a portion of the body 314. On a coupling end 326 of the body 314, the body 314 includes threads or other attachment components that allow the body 314 to be coupled to a working string (not shown) positioned in the wellbore. The working string is capable of rotating the body 314.

The downhole milling tool 310 further includes a plurality of blades 330 extending radially outward from the body 314. Each blade 330 extends along a portion of a length of the body and is arranged in a spiral or helical configuration on the body 314 relative to a longitudinal axis 334 of the body 314. In the embodiment illustrated in FIGS. 3A and 3B, a thickness of each blade 330 is substantially uniform. In other embodiments, the thickness of the blades 330 may be non-uniform, and each blade may be tapered such that a thicker portion of the blade 330 is adjacent a base 338 of the blade 330 where the blade 330 is coupled to the body 314.

The downhole milling tool 310 further includes a cladding material 342 coupled to one or more of the blades 330, and in some embodiments, the cladding material 342 is coupled to each of the blades 330. The cladding material 342 may be any material that has a higher hardness than the material from which the blade 330 is formed. In some embodiments, the hardness of the cladding material may be greater than or equal to approximately 60 HRC.

The hardness of the cladding material 342 and thus the wear resistance of the blade 330 may be supplemented by including a plurality of cutting inserts 350 coupled to the cladding material 342. The cutting inserts 350 may be at least partially embedded within the cladding material 342 such that the bond between the cladding material 342 and the cutting inserts 350 and between the cladding material 342 and the blade 330 secures the cutting inserts 350 to the blade 330. It should be noted that while some of the cutting inserts 350 may contact the blade 330, no bond necessarily exists between the cutting insets 350 and the blade 330. When cutting inserts 350 are coupled to the cladding material 342, a high-hardness iron-based cladding may be used, such as Apollo-Clad 1403 Powder supplied by Apollo-Clad. As explained in more detail below, powder-based cladding materials may be applied to a blade by using a laser to melt the powder and create the necessary bond between the cladding material and the blade or cutting inserts. Cladding materials such as the Apollo-Clad 1403 Powder have a hardness of approximately 60-65 HRC.

In some embodiments, as an alternative to the use of cutting inserts 350, the cladding material 342 alone may be coupled to the blade 330 and used to provide the increased cutting performance and wear resistance that is desired. In such an embodiment, it is desired that the cladding material 342 have an even higher hardness than materials used in conjunction with the cutting inserts 350. In some embodiments, it is desired that the hardness of such a material be greater than or equal to about 70 HRC. An example of a cladding material that may be coupled to the blade 330 and used alone without cutting inserts 350 is a material that includes approximately 62 weight percent Tungsten Carbide, approximately 30 weight percent Nickel, and approximately 6 weight percent Chromium. A suitable material may be WC200 supplied by Kennametal Conforma Clad of New Albany, Ind. The hardness of this material is approximately 64-70 HRC.

Like the milling tools 110, 210 illustrated in FIGS. 1A, 1B, 2A and 2B, the milling tool 310 may benefit from the metallurgical bond between the cladding material 342, the blades 330, and the cutting inserts 350, if applicable. Again, coupling of the cladding material 342 to the blades 330 (and to the cutting inserts 350 in certain embodiments) may be performed by various processes, including roll welding, explosive welding, and laser cladding.

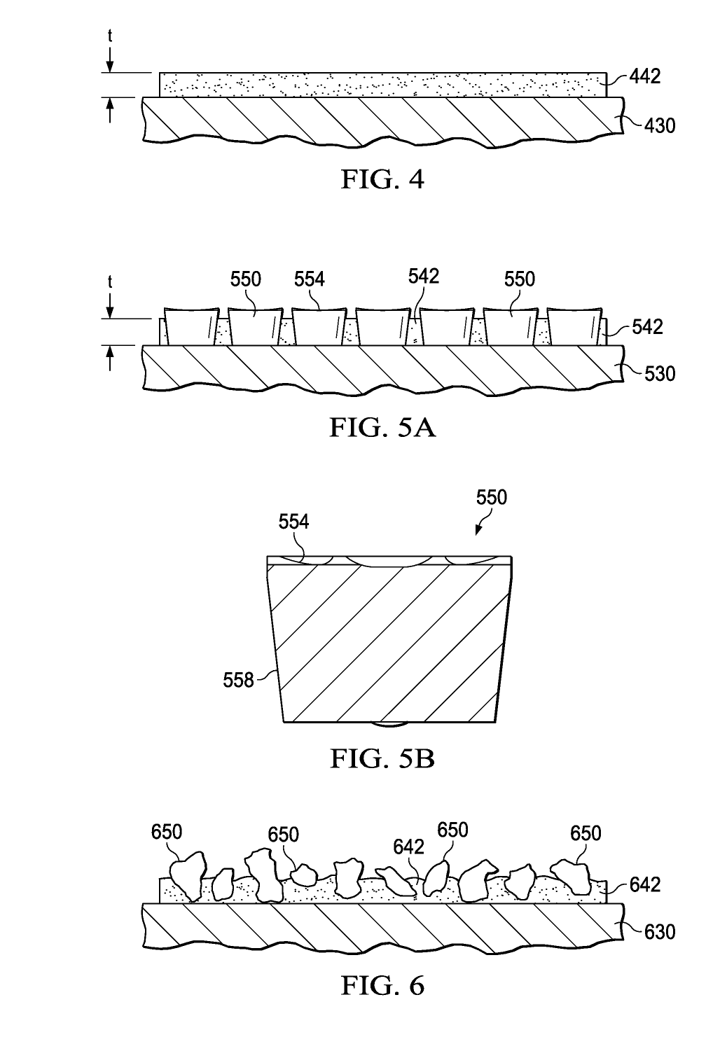

Referring to FIG. 4, a cross-sectional side view of a blade 430 of a milling tool is illustrated according to an illustrative embodiment. The blade 430 may be exemplary of any of the blades 130, 230, 330 previously described, or of the blade of any particular mill or milling tool. In the embodiment illustrated in FIG. 4, a cladding material 442 is coupled to the blade 430 in a manner similar to that described previously with reference to FIGS. 1A-3B. In this particular embodiment, the cladding material 442 is applied to the blade 430 such that a thickness, t, of the cladding material 442 is substantially uniform. In other embodiments, the thickness of the cladding material 442 may be non-uniform. In other embodiments, the cladding material 442 may be applied to create one or more ridges in the cladding material itself, the ridges have a greater thickness than other regions of the cladding material.

In FIG. 4, the cladding material 442 is illustrated as having a thickness approximately equal to the uniform thickness of blade 430. However, as discussed previously with reference to FIGS. 1A and 1B, in some embodiments, the thickness of the blades may be non-uniform. In these embodiments, and in other embodiments, the thickness of the cladding material 442 may be greater than or less than the thickness of the blades. In an illustrative embodiment, the thickness of the blade 430 may be approximately ½ inch and the thickness of the cladding material 442 may be approximately ⅜ inch.

Referring to FIG. 5A, a cross-sectional side view of a blade 530 of a milling tool is illustrated according to an illustrative embodiment. The blade 530 may be exemplary of any of the blades 130, 230, 330 previously described, or of the blade of any particular mill or milling tool. In the embodiment illustrated in FIG. 5A, a cladding material 542 is coupled to the blade 530 in a manner similar to that described previously with reference to FIGS. 1A-3B. In this particular embodiment, the cladding material 542 is applied to the blade 530 such a thickness, t, of the cladding material 542 is substantially uniform. In other embodiments, the thickness of the cladding material 542 may be non-uniform.

A plurality of cutting inserts 550 are coupled to the cladding material 542. The cutting inserts 550 may be arranged in a substantially uniform pattern and may be spaced apart a distance, x. In some embodiments, the cutting inserts may be arranged such that each cutting insert 550 contacts or abuts adjacent cutting inserts. In other embodiments, a more random spacing of the cutting inserts 550 may be employed. In FIG. 5A, each cutting insert 550 contacts the blade 530, and a distance or thickness of the cutting inserts 550 between the blade 530 and a cutting surface 554 of the cutting inset 550 is greater than the thickness of the cladding material 542. The cladding material 542, while of substantially uniform thickness in FIG. 5A, surrounds a portion of each cutting insert 550 and secures the cutting insert 550 by bonding to both the cutting insert 550 and the blade 530.

Referring to FIG. 5B, a cross-sectional view of the cutting insert 550 demonstrates that each cutting insert 550 is substantially cylindrical in shape, and the cutting surface 554 is scalloped such that the surface includes high points or ridges. In the embodiment illustrated in FIG. 5B, the cylindrical shape of the cutting insert 550 is tapered having a narrower base 558. In other embodiments, the shape of the cutting insert 550 may vary.

The cutting insert 550 may be formed from a material including approximately 71% tungsten carbide, 13% cobalt, 4% titanium carbide, and 12% tantalum carbide. Properties of the material may include a hardness of approximately 90.4 HRC. In some embodiments, a representative cutting insert may be ICBI270T supplied by Ibex Welding Technologies.

Referring to FIG. 6, a cross-sectional side view of a blade 630 of a milling tool is illustrated according to an illustrative embodiment. The blade 630 may be exemplary of any of the blades 130, 230, 330 previously described, or of the blade of any particular mill or milling tool. In the embodiment illustrated in FIG. 6, a cladding material 642 is coupled to the blade 630 in a manner similar to that described previously with reference to FIGS. 1A-3B. In this particular embodiment, the cladding material 642 is applied to the blade 630 such a thickness of the cladding material 642 is non-uniform. In other embodiments, the thickness of the cladding material 642 may be substantially uniform.

A plurality of cutting inserts 650 are coupled to the cladding material 642. The cutting inserts 650 may include crushed carbide elements that are size-screened to ensure that each crushed carbide element is an appropriate size. For example, the screening process may select for use cutting inserts 650 that are between a first volume and a second volume in size. Alternatively, screening may be performed to select cutting inserts 650 that meet particular dimensional measurements. For example, the screening process may use a mesh size that allows 3/16 inch to ¼ inch crushed carbide elements to be selected for use. The crushed carbide elements may be arranged randomly such that some of the crushed carbide elements contact the blade 630 and some do not. Similarly, while many of the crushed carbide elements, may protrude from the cladding material 642, some may be covered by the cladding material 642. The cladding material 642, while of non-uniform thickness in FIG. 6, surrounds a portion of most of the cutting inserts 650 and secures the cutting inserts 650 by bonding to both the cutting insert 650 and the blade 630.

Milling metal objects and other materials deposited in a wellbore may be key to forming additional lateral wellbores or to cleaning or re-sizing dowhole conduits in the wellbore. The present disclosure describes tools, systems, and methods for milling materials and improving the wear resistance of milling tools. In addition to the embodiments described above, many examples of specific combinations are within the scope of the disclosure, some of which are detailed below.

Example 1. A downhole milling tool comprising:
a mill body;
a plurality of mill blades radially extending from the mill body; and
a cladding material coupled to at least one of the mill blades.

Example 2. The downhole milling tool of example 2, wherein the cladding material has a hardness of approximately 60 HRC.

Example 3. The downhole milling tool of example 1, wherein the coupling between the cladding material and the at least one of the mill blades includes a metallurgical bond.

Example 4. The downhole milling tool of example 1 further comprising:
a plurality of cutting inserts coupled to the cladding material.

Example 5. The downhole milling tool of example 4, wherein the coupling between the plurality of cutting inserts and the cladding material includes a metallurgical bond.

Example 6. The downhole milling tool of example 1, wherein a hardness of the cutting inserts is greater than a hardness of the cladding material.

Example 7. The downhole milling tool of example 1, wherein the cutting inserts have a hardness of approximately 60 HRC.

Example 8. The downhole milling tool of example 1 further comprising: a plurality of cutting inserts coupled to the cladding material;
wherein each cutting insert is substantially cylindrical in shape and includes a scalloped cutting surface.

Example 9. The downhole milling tool of example 1 further comprising:
a plurality of cutting inserts coupled to the cladding material;
wherein each cutting insert is substantially cylindrical in shape and includes a cutting surface; and
wherein the cutting surface of at least one of the cutting inserts is located a distance from the mill blade greater than a distance from the mill blade to an outer surface of the cladding material.

Example 10. The downhole milling tool of example 1 further comprising:
a plurality of cutting inserts coupled to the cladding material;
wherein the cutting inserts are formed at least in part from tungsten carbide.

Example 11. The downhole milling tool of example 1 further comprising:
a plurality of cutting inserts coupled to the cladding material;
wherein the cutting inserts include crushed carbide elements that are size-screened with a mesh size of about 3/16 inch to about ¼ inch.

Example 12. The downhole milling tool of example 1 further comprising:
a plurality of cutting inserts coupled to the cladding material;
wherein the cutting inserts include crushed carbide elements that are size-screened to ensure that each crushed carbide element includes a dimension between a first amount and a second amount;
wherein the first amount is approximately 3/16 inch; and
wherein the second amount is approximately ¼ inch.

Example 13. A downhole milling tool for cutting non-geological materials in a well, the downhole milling tool comprising:
a body having an elongated and substantially cylindrical wall defining an inner passage extending through a portion of the body; the body having a coupling end capable of being coupled to a working string to rotate the body;
a plurality of blades extending radially outward from the body, each blade extending along a length of the body and being oriented substantially parallel to a longitudinal axis of the body or being arranged in a spiral or helical configuration on the body; and
a laser-deposited cladding material coupled to the plurality of blades.

Example 14. The downhole milling tool of example 13, wherein the cladding material is deposited on each of the plurality of blades in a substantially uniform thickness.

Example 15. The downhole milling tool of example 13 further comprising:
a plurality of cutting inserts coupled to the cladding material;
wherein each cutting insert is substantially cylindrical in shape; and
wherein the cladding material is deposited on each of the plurality of blades in a substantially uniform thickness.

Example 16. The downhole milling tool of example 13 further comprising:
a plurality of cutting inserts coupled to the cladding material;
wherein the cutting inserts include crushed carbide elements;
wherein at least a portion of the cutting inserts extend outward from the cladding material; and
wherein the cladding material is deposited on the blades in a non-uniform thickness.

Example 17. The downhole milling tool of example 1, wherein the downhole milling tool is one of a window mill, a watermelon mill, and a lead mill.

Example 18. A method of improving the wear resistance of downhole milling tool, the method comprising:
coupling a cladding material to a blade of the downhole milling tool.

Example 19. The method of example 18 further comprising:
coupling cutting inserts to the cladding material such that at least a portion of the cutting inserts protrude from the cladding material.

Example 20. The method of example 1, wherein the coupling the cladding material to the blade and coupling the cutting inserts to the cladding material further comprises:
delivering the cladding material in a powder form adjacent the blade; and
melting the powder using a laser.

It should be apparent from the foregoing that an invention having significant advantages has been provided. While the invention is shown in only a few of its forms, it is not limited to only these embodiments but is susceptible to various changes and modifications without departing from the spirit thereof.

We claim:

1. A downhole milling tool comprising:
a mill body;
a plurality of mill blades radially extending from the mill body; and
a cladding material coupled to at least one of the mill blades.

2. The downhole milling tool of claim 1, wherein the cladding material has a hardness of approximately 60 HRC.

3. The downhole milling tool of claim 1, wherein the coupling between the cladding material and the at least one of the mill blades includes a metallurgical bond.

4. The downhole milling tool of claim 1 further comprising:
a plurality of cutting inserts coupled to the cladding material.

5. The downhole milling tool of claim 4, wherein the coupling between the plurality of cutting inserts and the cladding material includes a metallurgical bond.

6. The downhole milling tool of claim 1, wherein a hardness of the cutting inserts is greater than a hardness of the cladding material.

7. The downhole milling tool of claim 1, wherein the cutting inserts have a hardness of approximately 60 HRC.

8. The downhole milling tool of claim 1 further comprising:
a plurality of cutting inserts coupled to the cladding material;
wherein each cutting insert is substantially cylindrical in shape and includes a scalloped cutting surface.

9. The downhole milling tool of claim 1 further comprising:
a plurality of cutting inserts coupled to the cladding material;
wherein each cutting insert is substantially cylindrical in shape and includes a cutting surface; and
wherein the cutting surface of at least one of the cutting inserts is located a distance from the mill blade greater than a distance from the mill blade to an outer surface of the cladding material.

10. The downhole milling tool of claim 1 further comprising:
a plurality of cutting inserts coupled to the cladding material;
wherein the cutting inserts are formed at least in part from tungsten carbide.

11. The downhole milling tool of claim 1 further comprising:
a plurality of cutting inserts coupled to the cladding material;
wherein the cutting inserts include crushed carbide elements that are size-screened with a mesh size of about 3/16 inch to about ¼ inch.

12. The downhole milling tool of claim 1 further comprising:
a plurality of cutting inserts coupled to the cladding material;
wherein the cutting inserts include crushed carbide elements that are size-screened to ensure that each crushed carbide element includes a dimension between a first amount and a second amount;
wherein the first amount is approximately 3/16 inch; and
wherein the second amount is approximately ¼ inch.

13. A downhole milling tool for cutting non-geological materials in a well, the downhole milling tool comprising:
a body having an elongated and substantially cylindrical wall defining an inner passage extending through a portion of the body; the body having a coupling end capable of being coupled to a working string to rotate the body;
a plurality of blades extending radially outward from the body, each blade extending along a length of the body and being oriented substantially parallel to a longitudinal axis of the body or being arranged in a spiral or helical configuration on the body; and
a laser-deposited cladding material coupled to the plurality of blades.

14. The downhole milling tool of claim 13, wherein the cladding material is deposited on each of the plurality of blades in a substantially uniform thickness.

15. The downhole milling tool of claim 13 further comprising:
a plurality of cutting inserts coupled to the cladding material;
wherein each cutting insert is substantially cylindrical in shape; and
wherein the cladding material is deposited on each of the plurality of blades in a substantially uniform thickness.

16. The downhole milling tool of claim 13 further comprising:
a plurality of cutting inserts coupled to the cladding material;
wherein the cutting inserts include crushed carbide elements;
wherein at least a portion of the cutting inserts extend outward from the cladding material; and
wherein the cladding material is deposited on the blades in a non-uniform thickness.

17. The downhole milling tool of claim 1, wherein the downhole milling tool is one of a window mill, a watermelon mill, and a lead mill.

18. A method of improving the wear resistance of downhole milling tool, the method comprising:
coupling a cladding material to a blade of the downhole milling tool.

19. The method of claim 18 further comprising:
coupling cutting inserts to the cladding material such that at least a portion of the cutting inserts protrude from the cladding material.

20. The method of claim 19, wherein the coupling the cladding material to the blade and coupling the cutting inserts to the cladding material further comprises:
delivering the cladding material in a powder form adjacent the blade; and
melting the powder using a laser.
